(19) United States
(12) Patent Application Publication
(10) Pub. No.: US 2018/0042203 A1
(43) Pub. Date: Feb. 15, 2018

(54) SYSTEM AND METHODS FOR MANAGING ANIMAL BEHAVIOR

(71) Applicants: Ashley Macomber, Los Angeles, CA (US); Rebecca Morales, Los Angeles, CA (US)

(72) Inventors: Ashley Macomber, Los Angeles, CA (US); Rebecca Morales, Los Angeles, CA (US)

(21) Appl. No.: 15/232,390

(22) Filed: Aug. 9, 2016

(51) Int. Cl. A01K 25/00

(52) U.S. Cl. CPC A01K 25/00

(57) ABSTRACT

The present invention is directed to a simplified system and methods for managing an animal's behavior. Preferred embodiments of the present invention include an apparatus formed from at least one pattern shaped from a single piece of material. In certain preferred embodiments, the at least one pattern may include a snout portion and one or more fastening elements. The size and shape of the snout portion may be defined by a first connecting edge, second connecting edge, anterior edge, and posterior edge. In some embodiments, the first connecting edge may be attached near or to the second connecting edge to form a configured pattern. The configured pattern may be positioned on an animal so that the snout portion surrounds the animal's snout limiting movement of the animal's lower jaw. In some embodiments, the configured pattern may include one or more edges sized and shaped to fit more comfortably on the animal's head.

### FIELD OF THE INVENTION

This invention generally relates to a simplified system and methods for managing the behavior of an animal. More particularly, preferred embodiments include an apparatus used to manage an animal's behavior by limiting movement of the animal's lower jaw preventing the animal from biting and barking. Advantageously, certain preferred embodiments of the apparatus may be formed from at least one pattern configured to fit more comfortably on the animal's head and not limit the animal's ability to smell, see, or hear. Other preferred embodiments may be made from a material or materials and configured to permit the apparatus to be used once or for a limited number of times.

### BACKGROUND OF THE INVENTION

The heads of some animals—such as dogs, cats, and horses—have similar anatomical features. They include a snout, nose, two eye orbitals, two eyes, and an occipital bone. The snout is often the dominant portion of the animal's head and includes the nose at the front end. The snout includes the maxilla and the mandible. The mandible is hingedly attached to the animal's head and is located underneath the maxilla. For the purposes of this invention, the mandible will be termed also a lower jaw. The two eye orbitals are located near the snout and to each side of the animal's head. The two eye orbitals house two forward facing eyes. At the back of the animal's head is an occipital bone which may protrude from the animal's head. The animal's head is generally attached to and supported by a neck.

At times, an owner may wish to take steps to manage an animal's behavior such as when the animal may show aggression towards humans or other animals, and/or display other undesirable behavior. In certain situations—such as while providing veterinary services, grooming services, or while walking the animal in a populated area—it may be beneficial for the service provider to prevent an animal's ability to bite or bark. One way to prevent the animal's ability to bite or bark is to limit movement of the animal's lower jaw.

A muzzle is one device that may be used to limit movement of the animal's lower jaw. Conventionally, a muzzle is sized and shaped so that it may be placed on and around the animal's snout limiting movement of the lower jaw. Many conventional muzzles may be configured to fit an animal's head having a certain size. Some conventional muzzles are sized and shaped so that portions of the muzzle are in the animal's line of sight thereby limiting the animal's vision. Other muzzles are sized and shaped so that portions of the muzzle partially cover the animal's nose thereby limiting the animal's ability to smell. Still other muzzles are sized and shaped so that portions partially cover the animal's ears thereby hindering the animal's ability to hear. Occasionally, muzzles are sized and shaped so that a portion protrudes near the animal's neck thereby possibly hindering the animal's ability to breathe.

Conventional muzzles are often formed from components made from hard and/or rigid material such as plastic and/or metal. While such muzzles made from hard and/or rigid material may have stronger structural integrity and make the muzzles resistant to damage such as by wear and tear, such muzzles often are not adjustable so that they can fit on animals having different sized and shaped heads. A muzzle of the wrong size may cause discomfort for the animal. Also, such muzzles may be more costly and owners may, as a result, use the muzzles for extended periods of time and on multiple animals raising the possibility that the muzzles may be dirty and a source of bacteria or viruses.

Some conventional muzzles are made from more flexible materials such as leather and/or fabric. A muzzle made from such materials may be more comfortable to wear than a muzzle made from hard and/or rigid material, yet may not be easily adjustable to fit a wide range of animals.

Conventional muzzles may be formed from a complex configuration of multiple parts. Such configurations may be more costly to manufacture, collect unwanted material such as dirt and parasites, and, if the configuration includes multiple straps and buckles, then the muzzle may be more difficult to quickly secure on an animal and/or remove from the animal.

There is a need for a simplified system and methods for managing an animal's behavior by limiting the movement of its lower jaw. The present invention satisfies this need.

### SUMMARY OF THE INVENTION

The present invention is directed to a simplified system and methods for managing an animal's behavior.

In certain preferred embodiments of the present invention, the system utilizes an apparatus formed from at least one pattern shaped from a single piece of material. The material may be smooth, flexible, and durable. In certain preferred embodiments of the apparatus, the pattern size and shape is defined by an anterior edge, a posterior edge, a first connecting edge, and a second connecting edge. The first connecting edge and the second connecting edge are sized and shaped and positioned relative to the other components of the apparatus such that the first connecting edge and second connecting edge can be joined near or to each other to form a configured pattern that may fit comfortably on the snout of an animal. The apparatus may include an exterior surface that is preferably smooth and an interior surface that may be shaped to permit the apparatus to fit ergonomically on the animal's snout. Preferably, the apparatus is sized and shaped such that when it is positioned on to the animal's snout, the anterior edge is adjacent to but not covering the animal's nose and the posterior edge is adjacent to but not covering or blocking the sight of the animal or constricting the animal's neck. The apparatus may be releasably secured to the animal by certain configurations of the apparatus or through use of one or more fastening elements. Overall, certain preferred embodiments of the system may include an apparatus having a low profile, that is one in which the exterior surface of the apparatus is not raised such that, when the apparatus is positioned onto the animal's snout, the animal's line of sight is not hindered.

In other certain preferred embodiments, the first connecting edge and the second connecting edge may be sized and shaped so that they may be joinable at a seam that is not raised generally above the exterior surface and/or interior surface. Such preferred embodiments, in which the seam is not raised relative to the exterior surface, may advantageously lessen the likelihood that an animal may remove the apparatus, for example, by scratching the muzzle.

In certain preferred embodiments, the apparatus may include a first pattern attached to a second pattern to form a combined pattern. In some embodiments, the first pattern may be shaped from a single piece of material that is the same or similar to the material from which the second pattern is shaped. For example, both the first pattern and the second pattern may be made from velvet or a velvet-like material that has one soft side and an opposing side that is not as soft. A combined pattern may be formed by attaching the not as soft sides of both patterns to each other so that the combined pattern has two soft sides.

In some preferred embodiments, the apparatus may include one or more support components for reinforcing the apparatus such as by providing additional layers of material. The one or more support components may be made of the same material as the pattern or may be made of one or more different materials joinable to the one or more patterns. In certain preferred embodiments, the one or more pattern may include extended portions that may be folded or otherwise configured to form such support components.

In certain preferred embodiments, the apparatus includes one or more fastening elements for securing the apparatus on an animal's head without covering the animal's ears so that the animal's ability to hear is not hindered. The one or more fastening elements may include one or more straps which may be attached to each other and/or the apparatus. Certain preferred embodiments of the apparatus include simplified straps that may permit the apparatus to be secured to an animal by tying. In some embodiments, the one or more fastening elements may be sized, shaped, and configured to adjust to the head of an animal such as by a ratchet-action clamp. In other embodiments, the one or more fastening elements may include one or more securing components such as a buckle.

In certain preferred embodiments, the pattern may be shaped from material that may be inexpensive yet durable and, given the low cost, permit the apparatus to be used once or a limited number of times. Such embodiments of the apparatus may be used by service providers who need to muzzle an animal while, for example, medical care is rendered to the animal, the animal is being groomed, or the animal is being moved quickly through an area with many people or other animals such as an airport, train station, or shopping mall. Such “disposable” embodiments of the apparatus may have a first connecting edge that may be attachable near or to the second connecting edge to permit the apparatus to be adjusted in size and shape so that it may be fitted and secured onto a wide range of animals. After use, the apparatus may be removed and disposed. By facilitating the removal and disposal of the apparatus, dirt, bacteria, and/or viruses from a first animal is not transferred to a second animal or subsequent animals thereby preventing the contamination of the other animals that is possible from the reuse of conventional muzzles.

One objective of the present invention is to provide a simplified system and methods for managing an animal's behavior.

Another objective of the present invention is to provide a simplified system including an apparatus formed from at least one pattern which may be easily configured to place over the snout of an animal for limiting movement of the animal's lower jaw without limiting the animal's sight, hearing, or smell.

Another objective of the present invention is to provide a simplified apparatus made from material that may be durable yet inexpensive and permit the apparatus to be used once or a limited number of times.

One advantage of the present invention is that certain preferred embodiments of the apparatus may be of a simple form thereby facilitating the quick use of the apparatus.

Another advantage of the present invention is that certain preferred embodiments of the apparatus may be comfortably worn on the head of an animal.

Another advantage of the present invention is that preferred embodiments of the apparatus may be worn by an animal without limiting the animal's sense of sight, hearing, or smell.

While this disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

### BRIEF DESCRIPTION OF THE DRAWINGS

The present invention can be better understood by reading the following detailed description of certain preferred embodiments, reference being made to the accompanying drawings in which:

FIG. 1A illustrates a preferred embodiment of a pattern of the present invention;

FIG. 1B illustrates an exploded view of a preferred embodiment of a combined pattern;

FIG. 1C illustrates a side view of a preferred embodiment of the pattern shown in FIG. 1A;

FIG. 1D illustrates a side view of a preferred embodiment of the present invention, such as the one shown in FIG. 1B (but non-exploded);

FIG. 2 illustrates a certain preferred embodiment of an apparatus formed from a pattern according to the present invention;

FIG. 3A illustrates a preferred embodiment of an apparatus including a pattern, such as the pattern illustrated in FIG. 1A, with a first connecting edge positioned in proximity to a second connecting edge;

FIG. 3B illustrates a preferred embodiment of the apparatus including a combined pattern in a configuration similar to that of the FIG. 1B illustrated embodiment and with a first connecting edge positioned in proximity to a second connecting edge;

FIG. 4 illustrates a preferred embodiment of the apparatus in which a first connecting edge is joined to a second connecting edge to form a generally non-raised seam;

FIG. 5A illustrates a certain preferred embodiment of the apparatus having a simplified form and in which the first connecting edge is attached to the surface of the snout portion adjacent to a second connecting edge;

FIG. 5B illustrates a preferred embodiment of the apparatus such as that one shown in FIG. 5A including a simplified attachment securement area and protective element by which the first connecting edge may be attached adjacent to the second connecting edge;

FIG. 6 illustrates a perspective view of a preferred embodiment of the apparatus including a configured pattern, such as the configured pattern illustrated in FIG. 4, with support components, fastening elements, and securing components;

FIG. 7 illustrates a perspective view of a preferred embodiment of the apparatus including a collar component for permitting the apparatus to be attached to an animal's collar;

FIG. 8 illustrates a perspective view of a preferred embodiment of the apparatus including a stabilizing component for stabilizing the apparatus permitting the apparatus to be stably secured to an animal's head;

FIG. 9A illustrates an embodiment of the apparatus secured on the head of an animal;

FIG. 9B illustrates a front view of an embodiment of a pattern, such as the pattern shown in FIG. 1A, including a compression component; and

FIG. 9C illustrates a front view of an embodiment of a pattern, such as the pattern shown in FIG. 1A, including a first compression component and a second compression component.

### DETAILED DESCRIPTION OF EMBODIMENTS

The present invention is directed to a simplified system 21 and methods for managing an animal's behavior.

The system 21 may include an apparatus 31 formed from at least one pattern 41 that may be configurable in size and shape such that the apparatus 31 may be to fitted over portions of an animal's head.

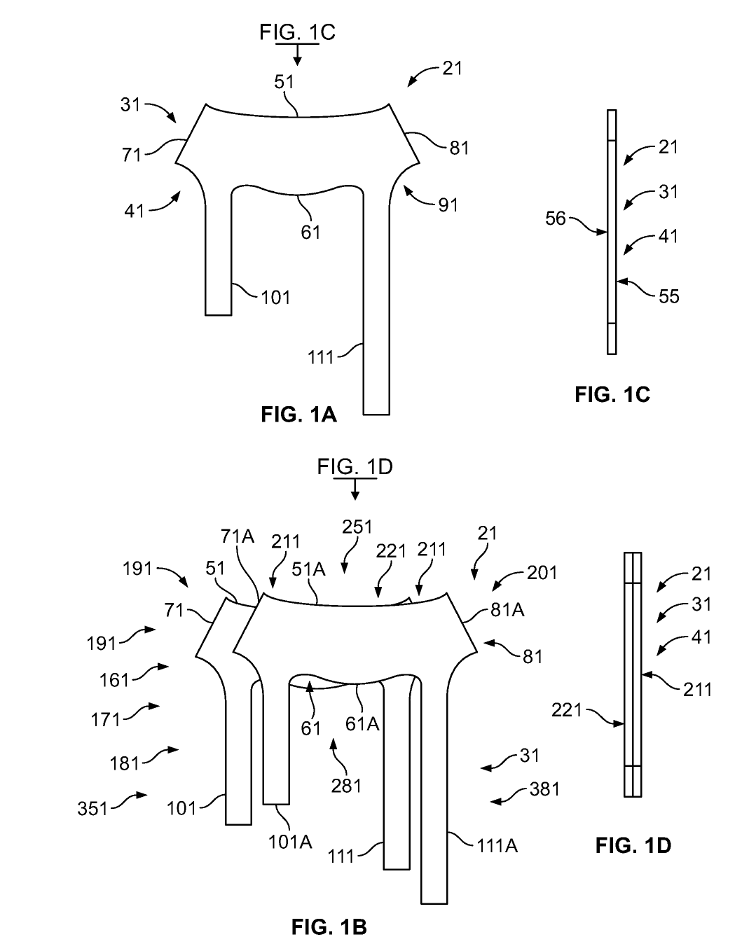

In the FIG. 1A illustrated embodiment, the pattern 41 comprises a single piece of material. In the FIG. 1A illustrated embodiment, an anterior edge 51, posterior edge 61, first connecting edge 71, and a second connecting edge 81 define the size and shape of the pattern 41 and the snout portion 91 of pattern 41. In the FIG. 1A illustrated embodiment, a first fastening element 101 and a second fastening element 111 extend from the snout portion 91. The apparatus 31 may be formed by attaching the first connecting edge 71 to the second connecting edge 81 to form a seam 131, an interior surface 141, and an exterior surface 151. The apparatus 31 may be placed on an animal's head so that the anterior edge 51, posterior edge 61, exterior surface 151, and interior surface 141 surround the animal's snout and the anterior edge 51 is adjacent but not covering the animal's nose—thereby not hindering the animal's ability to breathe.

In the FIG. 1A illustrated embodiment, the apparatus 31 includes a posterior edge 61 that is contoured so that a configured pattern 121 fits more comfortably on an animal's head. In the FIG. 1A illustrated embodiment, the posterior edge 61 is contoured so that the apparatus is spaced away from the animal's eyes to avoid hindering the animal's sight. In some embodiments, the posterior edge 61 is contoured so that the apparatus is spaced from the animal's neck and does not constrict the animal's throat and hinder breathing.

In certain preferred embodiments, the apparatus 31 formed from the pattern 41 illustrated in FIG. 1A may be secured on the animal by attaching the first fastening element 101 to the second fastening element 111. In some preferred embodiments, the first fastening element 101 may be securable to the second fastening element 111 by tying the first fastening element 101 to the second fastening element 111.

In certain preferred embodiments of the present invention, the apparatus 31 may be formed from a pattern 41 shaped from a single piece of material which is durable, flexible, and smooth. The apparatus 31 formed from a pattern 41 shaped from a single piece of material which is durable may resist wear and tear. The apparatus 31 formed from a pattern 41 shaped from a single piece of material which is flexible may permit the apparatus 31 to fit more easily onto the surface contours of the animal's head. In certain preferred embodiments, types of material which are durable, flexible, and smooth may be neoprene, velvet nylon, polyester, polyethylene, and polytetrafluoroethylene.

In some preferred embodiments of the present invention, a pattern 41, such as from FIG. 1A, may be shaped from light weight, durable, and inexpensive material so that an apparatus 31 may be used for a single or limited use. The apparatus 31 may be formed by attaching a first connecting edge 71 and/or second connecting edge 81 to the snout portion 91, such as by adhesive or Velcro®, permitting the apparatus 31 to be sizable to fit on an animal's head having a certain size and shape. Embodiments of the present invention which are shaped from inexpensive material may be disposed of after use on a particular animal for more sanitary management of the animal's behavior. FIG. 5A and FIG. 5B, discussed below in greater detail, illustrate such a preferred embodiment.

In certain preferred embodiments, the apparatus 31 includes a combined pattern 161 formed by attaching at least a first pattern 171 to a second pattern 181. The combined pattern 161 may have a combined pattern first connecting edge 191 which may be attached to a combined pattern second connecting edge 201 to form a configured pattern 121 with an exterior surface 151, interior surface 141, and seam 131.

FIG. 1B illustrates an exploded view of a combined pattern 161 showing portions of the first pattern 171 and the second pattern 181. The first pattern 171 may be attached to the second pattern 181 by sewing, adhesive, rivets, zipper, buttons, clamp, Velcro®, and/or any other means of connecting. Attaching the first pattern 171 to the second pattern 181 provides a first combined pattern surface 211 which is smooth and a second combined pattern surface 221 which is smooth.

In certain preferred embodiments, a combined pattern 161 may be formed by connecting a first pattern 171 of a certain size and shape to a second pattern 181 having the same size and shape. In some embodiments, a first pattern anterior edge 51 may be connected to a second pattern anterior edge 51A to form a combined pattern anterior edge 251. A first pattern posterior edge 61 may be attached to a second pattern posterior edge 61A to form a combined pattern posterior edge 281. A first pattern first connecting edge 71 may be attached to a second pattern first connecting edge 71A to form a combined pattern first connecting edge 191. A first pattern second connecting edge 81 may be attached to a second pattern second connecting edge 81A to form a combined pattern second connecting edge 201. In some embodiments, a first pattern first fastening element 101 may be attached to a second pattern first fastening element 101A to form a combined pattern first fastening element 351. In some embodiments, a first pattern second fastening element 111 may be attached to a second pattern second fastening element 111A to form a combined pattern second fastening element 381.

FIG. 1C illustrates the side view of a pattern 41, such as shown in FIG. 1A, having a first face surface 55 and an opposing second face surface 56. Depending on the configuration of the pattern 41, the first face surface 55 may provide a smooth interior surface 141 and the second face surface 56 may provide a smooth exterior surface 151. In other embodiments, the first face surface 55 may provide a smooth exterior surface 151 and the second face surface 56 may provide a smooth interior surface 141. In the FIG. 1C illustrated embodiment, the first face surface 55 and the second face surface 56 are smooth.

FIG. 1D illustrates the side view of a combined pattern 161, such as shown in FIG. 1B, having a first combined pattern surface 211 and a second combined pattern surface 221. Depending on the configuration of the combined pattern 161, the first combined pattern surface 211 may provide a smooth interior surface 141 and the second combined pattern surface 221 may provide a smooth exterior surface 151. In other embodiments, the first combined pattern surface 211 may provide a smooth exterior surface 151 and the second combined pattern surface 221 may provide a smooth interior surface 141. In the FIG. 1D illustrated embodiment, the first combined pattern surface 211 and the second combined pattern surface 221 are smooth.

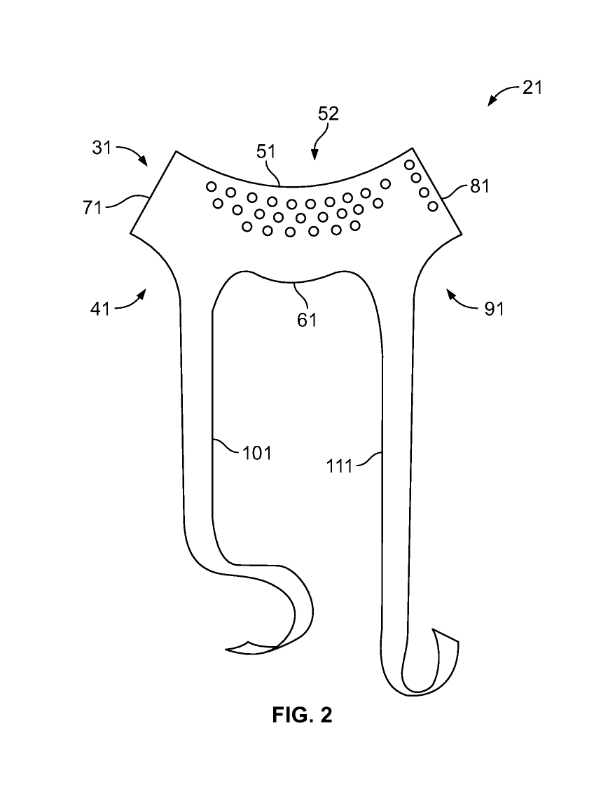

FIG. 2 illustrates a certain preferred embodiment of an apparatus 31 formed from a pattern 41. The FIG. 2 illustrated embodiment of the apparatus 31 includes an anterior edge 51, posterior edge 61, first connecting edge 71, and a second connecting edge 81 that define the size and shape of a snout portion 91. The FIG. 2 illustrated embodiment of the snout portion 91 includes perforations 52 that may provide ventilation. The FIG. 2 illustrated embodiment includes a first fastening element 101 and a second fastening element 111, each of which extends from the posterior edge 61 of the snout portion 91. The first fastening element 101 may be the same length as the second fastening element 111. In some preferred embodiments, a simplified embodiment of the apparatus, such as shown in FIG. 2, may be formed by attaching an additional pattern or patterns to the illustrated pattern 41 to form a combined pattern 161.

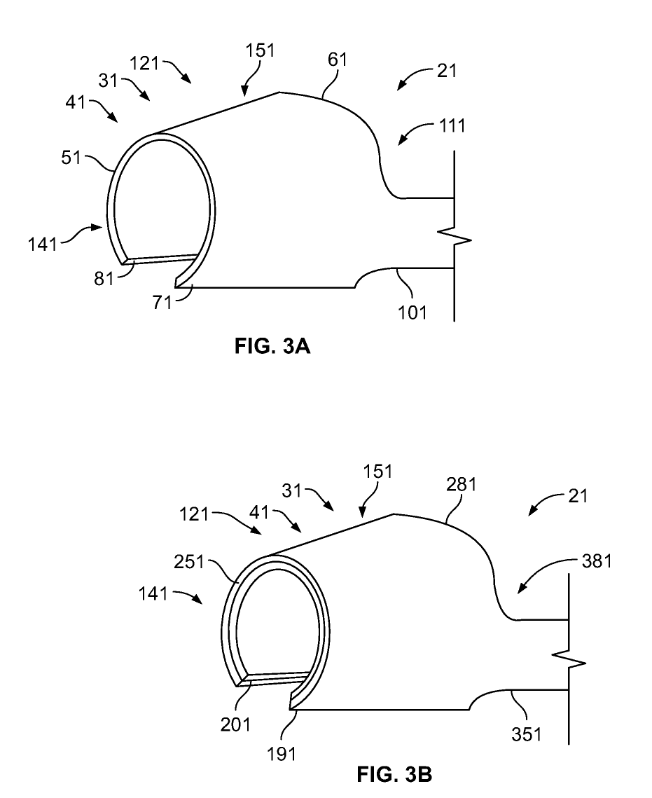

FIG. 3A illustrates a certain preferred embodiment of an apparatus 31 formed from a pattern 41, such as the pattern shown in FIG. 1A, having a first connecting edge 71 that may be placed in proximity to a second connecting edge 81. The first connecting edge 71 may be attached to the second connecting edge 81 by sewing, rivets, adhesive, zipper, buttons, clamp, Velcro®, and/or any other known means for fastening. Attaching the first connecting edge 71 to the second connecting edge 81 to form a configured pattern 121 provides an exterior surface 151, an interior surface 141, and a single seam 131 (not shown in FIG. 3A).

FIG. 3B illustrates a certain preferred embodiment of an apparatus 31 formed from a combined pattern 161 similar to the embodiment illustrated in FIG. 1B. The combined pattern 161 may be configurable in the same way as the FIG. 3A illustrated embodiment. In the FIG. 3B illustrated embodiment, a combined pattern first connecting edge 191 may be placed in proximity to a combined pattern second connecting edge 201. The combined pattern first connecting edge 191 may be attached to the combined pattern second connecting edge 201 such as by sewing, rivets, adhesive, zipper, buttons, clamp, Velcro®, and/or any other known means for fastening. Attaching the combined pattern first connecting edge 191 to the combined pattern second connecting edge 201 to form a configured pattern 121 may provide an exterior surface 151, an interior surface 141, and a single seam 131 (not shown in FIG. 3B).

In some embodiments, the material of the first pattern 171 and/or the material of the second pattern 181 may be selected to provide certain properties to the apparatus 31. For example, a combined pattern 161 formed by connecting a first pattern 171 shaped from velvet and a second pattern 181 shaped from velvet may be configured so that an interior surface 141 is soft and an exterior surface 151 is soft. In some embodiments, the interior surface 141 may have different properties than the exterior surface 151. For example, a combined pattern 161 formed by connecting a first pattern 171 made from neoprene and a second pattern 181 made from velvet may be configured so that an interior surface 141 is soft and an exterior surface 151 is water resistant.

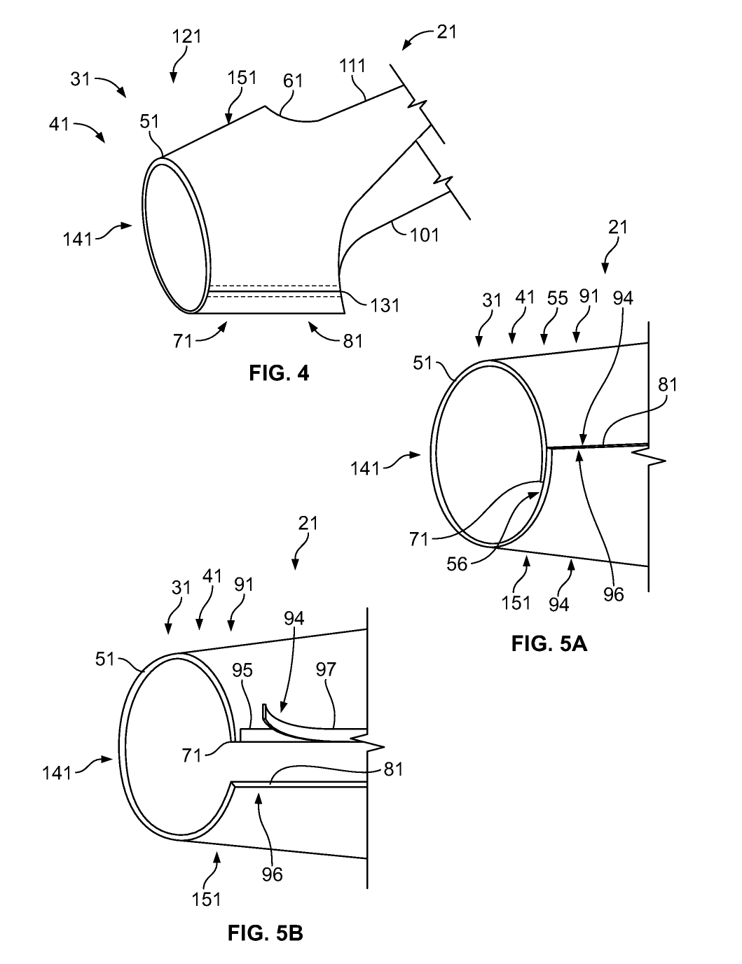

FIG. 4 illustrates a certain preferred embodiment of an apparatus 31 including a configured pattern 121 having a seam 131 formed by attaching a first connecting edge 71 to a second connecting edge 81. FIG. 4 shows the apparatus 31 rotated so that seam 131 (which in certain embodiments is positioned below the animal's mandible) is viewable. In the FIG. 4 illustrated embodiment, the seam 131 is continuous along the first connecting edge 71 and the second connecting edge 81. The FIG. 4 illustrated preferred embodiment is formed from one pattern 41, but other preferred embodiments may be formed from a combined pattern 161.

In certain preferred embodiments, such as the FIG. 4 illustrated embodiment, first connecting edge 71 and second connecting edge 81 may be configured to be joined to form a seam 131 which is smooth. The seam 131 which is smooth illustrated in FIG. 4 is even with and does not protrude above the exterior surface 151 and/or interior surface 141 of the configured pattern 121. Advantageously, an apparatus 31 having such a seam 131 may make it less likely that an animal may place its nails or claws in the seam 131 and damage or remove the apparatus 31.

FIG. 5A and FIG. 5B illustrate another preferred embodiment of an apparatus 31. The apparatus 31 shown in FIGS. 5A and 5B may be formed from one or more flexible and durable materials that may also be inexpensive. Such choice of material may permit the apparatus 31 to be disposed after a single or a limited number of uses. The apparatus 31 may be formed from a pattern 41 shaped from a single sheet of material by securing a first portion 94 of a first face surface 55 adjacent to a first connecting edge 71 to a second portion 96 of a second face surface 56 adjacent to a second connecting edge 81. Among the elements that may be used to accomplish this securement, an adhesive strip or Velcro® may be used. Given the material's preferred flexibility, the apparatus 31 illustrated in FIG. 5A is sizable so that the size and shape of the apparatus 31 may be adjusted to fit a variety of animals.

FIG. 5B illustrates a certain preferred embodiment of an apparatus 31 including a securement area 95 and a protective element 97 to provide for selective formation of the apparatus 31. The securement area 95 may be comprised of material which may facilitate attachment of a first portion 94 of the apparatus 31 to a second portion 96 such as by adhesive. In FIG. 5B, the securement area 95 is located adjacent to the first connecting edge 71 on the exterior surface 151. The protective element 97 may be comprised of a material which resists the attachment of the first portion 94 of the apparatus 31 to the second portion 96 and the protective element 97 may overlap the securement area 95. A user may selectively form the apparatus 31 by removing the protective element 97 and attaching the securement area 95 to a portion of the apparatus 31. By moving the first portion 94 relative to the second portion 96, the apparatus 31 may be adjusted in size and shape to fit a variety of animals.

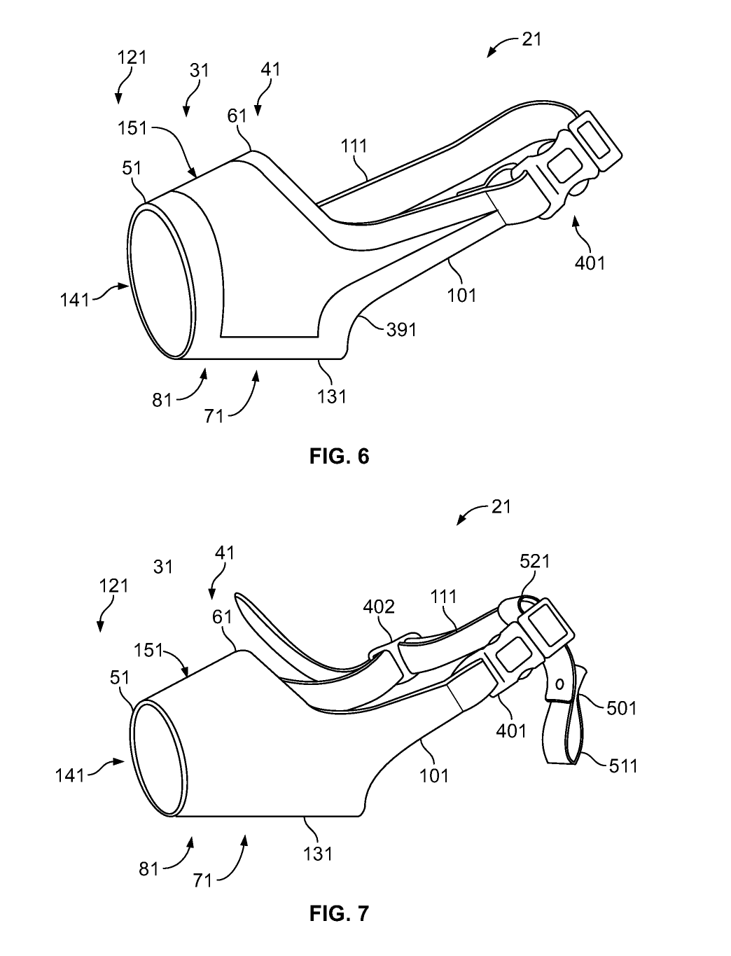

FIG. 6 illustrates a preferred embodiment of an apparatus 31 with a support component 391 for reinforcing the apparatus. In the FIG. 6 illustrated embodiment, the support component 391 is joined to the exterior surface 151 of the apparatus 31 as an extra layer of a flexible and resilient material such as leather, vinyl, neoprene, velvet, nylon, polyester, polyethylene, and/or polytetrafluoroethylene. As illustrated in FIG. 6, the support component 391 is joined to the apparatus 31 at the anterior edge 51, posterior edge 61, first connecting edge 71, second connecting edge 81, first fastening element 101, second fastening element 111, and snout portion 91 providing additional layers of the material so that the apparatus 31 may be more resistant to wear and tear. In some preferred embodiments, one or more support components may be joined to the interior surface 141 and/or exterior surface 151. In some embodiments, one or more surface of the support component 391 may be reflective.

In some preferred embodiments, an apparatus 31 having one or more support components 391 may be formed from the single piece of material from which a pattern 41 is shaped. The anterior edge 51, posterior edge, 61, first connecting edge 71, and/or second connecting edge 81 of the pattern 41 may be extended thereby permitting one or more support components 391 to be formed by folding and attaching the anterior edge 51, posterior edge, 61, first connecting edge 71, and/or second connecting edge 81 to the interior surface 141 and/or exterior surface 151 such as by sewing, rivets, adhesive, zipper, buttons, clamp, Velcro®. The one or more support components 391 provide for additional layers of material so that the apparatus 31 may be more resistant to wear and tear.

FIG. 7 illustrates a preferred embodiment of the system 21 including an apparatus 31 with a configured pattern 121 including a collar component 501 for securing the apparatus 31 to an animal's collar (not shown). In the FIG. 7 illustrated embodiment, the collar component 501 includes an apparatus loop 521 and collar loop 511 configured to permit the collar component 501, and thereby the apparatus 31, to be secured to the collar of the animal. The collar component 501 may be formed of flexible material so that a user map wrap the apparatus loop 521 around a portion of the apparatus 31, for example, the second fastening element 111, and attach the apparatus loop 521 to the collar component 501 such as by a snap. The collar loop 511 may be wrapped around a portion of the animal's collar and attached to the collar component 501 such as by a snap.

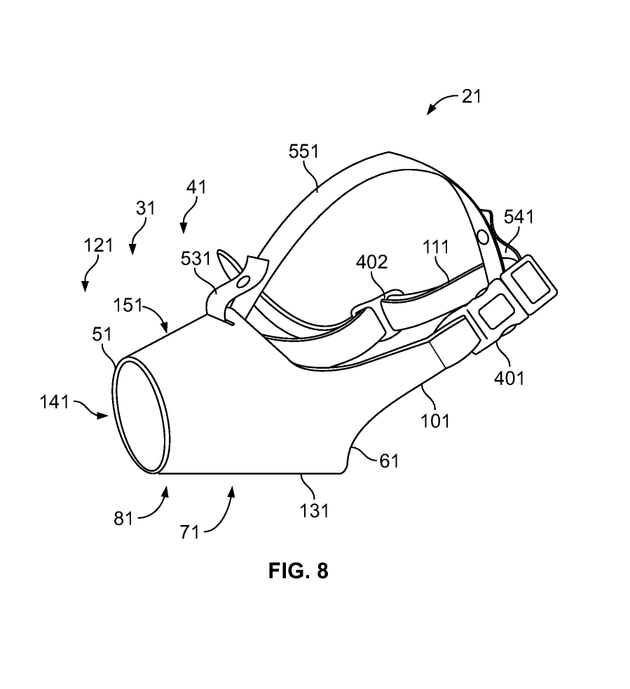

FIG. 8 illustrates a preferred embodiment of the system 21 including an apparatus 31 including a stabilizing component 521 sized and shaped to fit over the animal's head and stabilize the movement of the apparatus 31. In the FIG. 8 illustrated embodiment, the stabilizing component 551 that includes a snout loop 531 and a fastening element loop 541. The stabilizing component 551 may be formed from flexible material so that a user may wrap the snout loop 531 around the posterior edge 61 of the apparatus 31 and attach the snout loop 531 to the stabilizing component 521 such as by a snap. The fastening element loop 541 may be wrapped around the second fastening element 111 and attached to the stabilizing component 551 such as by a snap. The stabilizing component 551 may be sized and shaped 121 so that the stabilizing component 551 is between an animal's eye orbitals and extends over the top of the animal's head without obstructing the animal's sight or hearing.

FIG. 8 also includes an adjustment component 402 for adjusting the size and fit of the apparatus 31. In FIG. 8, the adjustment component 402 is a slide adjuster sized and shaped so a second fastening element 111 may be threaded through the adjustment component 402. The adjustment component may be slideable over the second fastening element 111 for adjusting the size and fit of the apparatus 31.

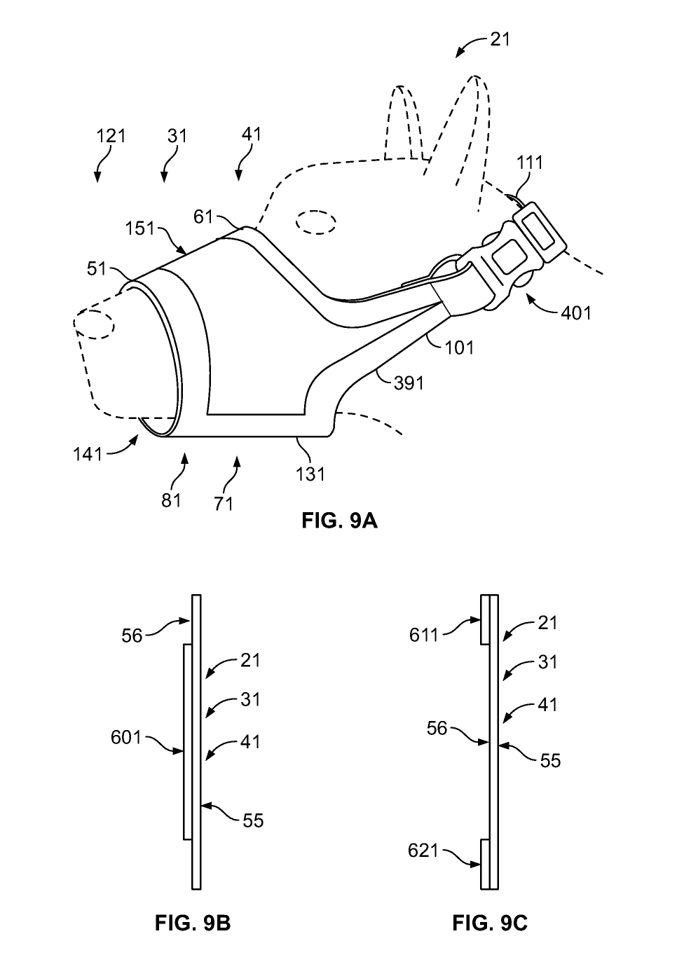

FIG. 9A illustrates an embodiment of the present invention including an apparatus 31 secured on an animal's head. The apparatus 31 illustrated in FIG. 9A is formed from a pattern 41 shaped from a single piece of material. A size and shape of the pattern 41 is defined by an anterior edge 51, posterior edge 61, first connecting edge 71, and second connecting edge 81. In the FIG. 9A illustrated embodiment, a configured pattern 121 is formed by attaching a first connecting edge 71 to a second connecting 81 edge at a single seam 131. The configured pattern 121 is shown fitted on the head of an animal so that the anterior edge 51 is near but spaced from the animal's nose, the posterior edge 61 is adjacent to but spaced from the animal's eyes and neck, and an interior surface 141 is surrounding and in contact with at least a portion of the animal's snout. The posterior edge 61 illustrated in FIG. 9A is contoured so that it is on the animal's snout near the animal's eyes without covering the animal's eyes. The exterior surface 151 is smooth providing the apparatus 31 with a low profile so that it does not impair the animal's vision.

In the FIG. 9A illustrated embodiment, the apparatus 31 includes a first fastening element 101, a second fastening element 111, and a securing component 401. In FIG. 9A, the first fastening element 101 extends from the posterior edge 61 on the left and towards the back of the animal's head, and the second fastening element 111 extends from the posterior edge 61 on the right and wrapping around the occipital bone of the animal's head. The first fastening element 101 is attached to the second fastening element 111 of the left side of the animal's head by a securing component 401. Neither the first fastening 101 element nor the second fasting element 111 covers the animal's ears. The securing component 401 illustrated in FIG. 9A is a buckle which may facilitate more easily securing and/or removing the apparatus 31 on the animal's head. In alternative embodiments, the pattern 41 may include a first fastening element 101 which may attach to the exterior surface 151 of the configured pattern 121.

The FIG. 9A illustrated embodiment includes an apparatus 31 sized and shaped to have a generally lose fit on the animal's head. In FIG. 9A the apparatus 31 is generally loose near the anterior edge 51 so that a space forms between the animal's lower jaw and the interior surface 141 of the apparatus. The generally loose fit permits movement of a limited range of the animal's lower jaw so that the animal may pant. In other preferred embodiments, an apparatus may be made of material which is elastic to permit the animal to have movement of its lower jaw of a limited range so that the animal may pant. In other preferred embodiments, the apparatus 31 shown in FIG. 9A may include one or more compression components which may facilitate similar limited movement of the animal's lower jaw.

The FIG. 9B illustrated embodiment is a front view of a pattern 41, such as shown in FIG. 1A, used to form an apparatus 31, such as shown in FIG. 9A, including a single compression component 601 attached to the interior surface 141. The single compression component 601 may be made of a compressible material such as a gel or foam. The single compression component 601 may be located on the second face surface 56 of the pattern 41 and be sized and shaped to contact an animal's snout adjacent to the maxilla when the configured pattern 121 is formed. The single compression component 601 may deform if the animal opens its lower jaw and reform if the animal closes its lower jaw.

The FIG. 9C illustrated embodiment is a front view of a pattern 41, such as shown in FIG. 1A, used to form an apparatus 31, such as shown in FIG. 9A, including a first compression component 611 and a second compression component 621 attached to the interior surface 141. The first compression component 611 and second compression component 621 may be made of a compressible material such as a gel or foam. The first compression component 611 and the second compression component 621 may be located on the second face surface 56 of the pattern 41 sized and shaped to contact the animal's lower jaw when the configured pattern 121 is formed. The first compression component 611 and second compression component 621 may deform if the animal opens its lower jaw and reform if the animal closes its lower jaw permitting the animal to pant.

While the disclosure is susceptible to various modifications and alternative forms, specific exemplary embodiments of the invention have been shown by way of example in the drawings and have been described in detail. It should be understood, however, that there is no intent to limit the disclosure to the particular embodiments disclosed, but on the contrary, the intention is to cover all modifications, equivalents, and alternatives falling within the scope of the disclosure as defined by the appended claims.

What is claimed is:

1. An apparatus for managing behavior of an animal comprising:
a pattern shaped from a single piece of material including a snout portion and one or more fastening elements extending from said snout portion;
said snout portion having a size and shape defined by a first connecting edge, second connecting edge, anterior edge, and posterior edge;
said first connecting edge and said connecting edge sized and shaped and positioned such that said first connecting edge is securable near or to said first connecting edge and a configured pattern is formed having an interior surface, an exterior surface, and a seam;
said configured pattern sized and shaped so the interior surface generally surrounds and is in contact with the animal's snout when said apparatus is place onto the animal; and
said one or more fastening elements attached to secure said apparatus on the animal's head for managing the animal's behavior.

2. The apparatus for managing an animal's behavior according to claim 1, wherein said first portion includes a securement area.

3. The apparatus for managing an animal's behavior according to claim 1, wherein said second portion includes a securement area.

4. The apparatus for managing an animal's behavior according to claim 1, wherein said pattern is shaped from polyethylene.
